(19) United States
(12) Patent Application Publication
(10) Pub. No.: US 2018/0183836 A1
(43) Pub. Date: Jun. 28, 2018

(54) DISCOVERY DRIVEN WEB-BASED APPLICATION RESOURCE PROTECTION

(71) Applicant: CA, Inc., New York, NY (US)

(72) Inventor: Sami Ahmed Shaik, Ashland, MA (US)

(21) Appl. No.: 15/391,841

(22) Filed: Dec. 28, 2016

(51) Int. Cl. H04L 29/06

(52) U.S. Cl. CPC H04L 63/205; H04L 63/10

(57) ABSTRACT

A discovery driven web-based application resource security analyzer (“resource security analyzer”) can be designed that learns the protection status of application resources and the desired protection status of application resources and rectifies differences between the protection status and desired protection status. The resource security analyzer can do this efficiently at an enterprise scale. When initialized, the resource security analyzer goes through a learning phase, wherein an agent(s) of the resource security analyzer discovers the resources accessed by the application requests. The resource security analyzer determines the protection status. A report on the protection statuses of the resources is generated and displayed. Upon an indication to protect the resource, the resource security analyzer goes through a configuration phase, wherein the agent(s) may determine a protection domain for the resource, determines the security policy to be associated with the protection domain, and adds the resource to the protection domain.

### BACKGROUND

The disclosure generally relates to the field of information security, and more particularly to database and file management or data structures.

Security policies define relationships or rules for authorization, access control, and trust of resources in a certain domain. Domains can be hierarchical, and the hierarchical relationship can be indicated with child domains as subdomains. A rule specifies a condition(s) for controlling access to a resource. A resource is an application component or object (e.g., a file) that can be secured by a security policy.

### BRIEF DESCRIPTION OF THE DRAWINGS

Aspects of the disclosure may be better understood by referencing the accompanying drawings.

FIG. 1 depicts an example system for learning and configuring protection status for application resources.

FIG. 2 depicts a flowchart depicting the learning phase of the resource security analyzer.

FIG. 3 depicts a flowchart depicting the configuration phase of the resource security analyzer.

FIG. 4 depicts an example computer system with a resource security analyzer.

### DESCRIPTION

The description that follows includes example systems, methods, techniques, and program flows that embody aspects of the disclosure. However, it is understood that this disclosure may be practiced without these specific details. For instance, this disclosure refers to a web application in illustrative examples. Aspects of this disclosure can be also applied to other types of applications such as a systems application. In other instances, well-known instruction instances, protocols, structures, and techniques have not been shown in detail in order not to obfuscate the description.

Overview

Preparing for deployment of a web-based application should include evaluating exposure of the various resources of the application. Although some resources are intended to be exposed without protection, a web-based application is often designed with some resources intended to be protected according to a security policy. Since a web application may contain hundreds if not thousands of resources, determining whether numerous resources of a web-based application are adequately protected can be time-consuming.

A discovery driven web-based application resource security analyzer (“resource security analyzer”) can be designed that learns the existing protection statuses of application resources and the desired protection statuses of application resources and that rectifies differences between the existing and the desired protection statuses of the application resources. The resource security analyzer can do this efficiently at an enterprise scale. The resource security analyzer initially goes through a learning phase. During the learning phase, an agent(s) of the resource security analyzer detects application requests submitted to a server process of the application. The resource security analyzer identifies resources exposed or accessed by the application requests. In addition, the resource security analyzer determines whether the identified resources are protected. The resource security analyzer generates a report on the determined protection statuses of the identified resources and learns desired protection statuses of the identified resources. With the desired protection statuses, the resource security analyzer begins a configuration phase to change protection statuses of resources based on the desired protection statuses. During the configuration phase, the resource security analyzer determines a protection domain(s) for the resources for which protections statuses are to change. The resource security analyzer then determines a security policy to be associated with the protection domain. The resource security analyzer then adds the resources being changed to protected to the protection domain.

### Example Illustrations

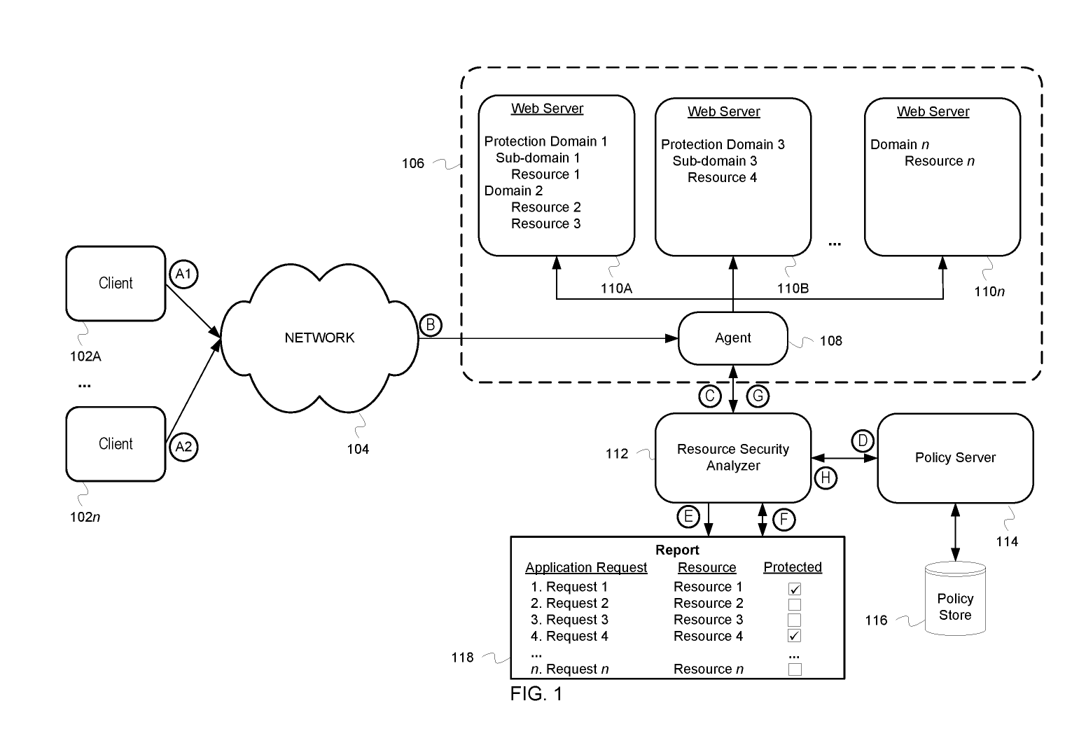

FIG. 1 depicts an example system for learning and configuring protection status for application resources. FIG. 1 includes a number of clients 102A through 102n (“clients 102”) sending requests to a web-based application (“application”) 106 through a network 104. In this example, the application 106 is hosted by web servers 110A through 110n (“web servers 110”). The web servers 110 can be located remotely from one another or co-located. An agent 108 of a resource security analyzer 112 has been associated with the application 106.

FIG. 1 is annotated with a series of letters A (A1, A2)-H. These letters represent stages of operations. Although these stages are ordered for this example, the stages illustrate one example to aid in understanding this disclosure and should not be used to limit the claims. Subject matter falling within the scope of the claims can vary with respect to the order and some of the operations.

Prior to stage A1, the resource security analyzer 112 begins monitoring requests from clients to the application 106. The resource security analyzer 112 may begin monitoring based on detecting an indication of the application 106 (e.g., indication of the application 106 in a command or user interface, loading the application 106 into a browser application, etc.) that associates the resource security analyzer 112 with the application 106. The resource security analyzer 112 may begin monitoring based on activation of a first mode of operation (“learning mode”) after already being associated with the application 106. Associating the resource security analyzer 112 may involve associating the agent 108 (included with the resource analyzer 112) with the web servers 110 hosting the application 106. Associating the agent 108 can involve injecting the agent 108 into web servers 110 or activating the agent 108 in the learning mode when the agent 108 is an extension or plug-in to another application that presents the application 106 (e.g., a web browser application).

At stage A1, the client 102A sends application requests to the application 106 through the network 104. The application request sent to the application 106 may begin with the name of the web server hosting the application 106 followed by the application name. For example, a uniform resource locator (URL) of the application request may be of the format: http://webserver-name/web-application-name. The application 106 may use resources such as images, hypertext markup language (HTML) files, forms, databases, script files, Java® archive (JAR) files, etc. to service application requests. These resources can be accessed through application requests. As another example, an application request may use the format http://webserver-name/application-name/library-name/resource-name. An application request may also be sent to an application component (e.g., servlets, libraries, etc.) which in turn accesses the resources, such as a database, to process requests and/or construct responses. For example, a servlet might invoke remote methods that retrieve information from a database. An application request that is sent to a servlet may be of a format http://webserver-name/web-application-name/servlet-name. In a same or overlapping period of time at stage A2, another client depicted as client 102 sends application requests to the application 106 through the network 104.

At stage B, the agent 108 detects the application requests sent by the clients 102 to the application 106 through the network 104. The agent 108 records or logs the detected application requests. These records may be written in a plain text file. Custom logging fields may be added such as request headers, response headers, etc. The agent 108 generates a list from the recorded application requests. The generated list may be an abstract data type such as an arrayList. The generated list may include information such as the process, user, and/or role identifiers requesting access to the resource, an operation to be performed, a date and time of the application request, etc.

At stage C, the agent 108 transmits the generated list to the resource security analyzer 112. The resource security analyzer 112 determines the resources associated with the application requests. The resource security analyzer 112 determines the resources by extracting the resource identifier contained in the request header field of the application requests. The resource security analyzer 112 also maps the application requests to each of the resources accessed by the application requests. The relationship between the application requests and the resources may be a one-to-one, one-to-many, etc. For example, the relationship between the application requests and the resources may be one-to-many since one application request may access more than one resource (e.g., a servlet accessing a database and image file in constructing a response). These resources may also be indicated through the request such as in the header, body, etc. The relationship may be indicated using a data structure (e.g., associate array, dictionary, etc.) loaded into memory.

The resource security analyzer 112 communicates with a policy server 114 to determine whether the resources being accessed by the application requests are protected. The resource may be represented by a resource object. The resource object may be a data structure that contains the properties of the resource (e.g., resource identifier, resource type, resource attributes, resource associations, date and time of creation, etc.). The resource may be associated with a protection domain. The protection domain is associated with a security policy or a set of security policies. The resource may also be associated with a security policy directly without being associated with a protection domain. The resource object also indicates the associations with a security policy and/or protection domain (e.g., the resource object includes a domain identifier and/or a policy identifier).

At stage D, the policy server 114 queries a policy store 116 to determine whether the resources determined from the list are protected. The policy store 116 is a repository of the security policies. The policy store can be file-based (e.g., XML file), a database, lightweight directory access protocol (LDAP) based, etc. The policy server 114 queries the policy store 116 to determine whether a security policy is associated with the resources or a protection domain each of the resources is a member of. The resource is protected if the resource is associated with security policy or associated with a protection domain.

At stage E, the resource security analyzer 112 generates the report 118 based on responses from the policy server. The report 118 contains a list of the application requests and the resources accessed by the application requests. The report 118 also contains the protection status of each of the resources accessed by the application requests. The generated report may be saved in various formats such as a text or extensible markup language (XML) file format. The report may also be displayed in a graphical user interface “dashboard.” In this example, the report 118 is an interactive report that shows the protection status of a resource with a checkbox. A checked checkbox (e.g., checkbox that contains a tick mark) indicates that the resource associated with the checkbox is protected. An unchecked checkbox indicates that the resource associated with the checkbox is unprotected.

At stage F, the resource security analyzer 112 begins a second mode of operation (“configuration mode”). The resource security analyzer 112 learns or determines the desired protection status of each of the resources in the report 118. In this example illustration, the resource security analyzer 112 detects changes in the checkboxes to determine desired protection statuses of the identified resources. The changes in the checkboxes of the user interface presented report 118 may be performed manually by an administrator of the application 106. The administrator selects the checkboxes of the resources to be protected. The resource analyzer 112 detects the selected checkboxes in the report 112 and records the resource identifiers of the resources to be protected.

At stage G, the resource security analyzer 112 updates the protection domains in the web servers 110 accordingly. For example, the resource security analyzer 112 creates the protection domain in the web servers 110 if the desired protection domain does not exist and adds the resource to the protection domain. If the desired protection domain already exists, then the resource security analyzer 112 adds the resource to the protection domain.

At stage H, the resource security analyzer 112 communicates with the policy server 114 to associate the protection domain and/or subdomain with a security policy. A protection domain may not be initially associated with a security policy after its creation. If the protection domain is not associated with a security policy, the policy server associates the protection domain and/or subdomain to the security policy. The changes to the protection status of the resources and the updates to the protection domains in the web servers 110 may also be logged and/or cached by the resource security analyzer 112. The resource security analyzer 112 may also use this information to query the protection status of the resources accessed by the clients 102 before communicating with the policy server 114. The resource security analyzer 112 may also use this information to query the date and time when the protection resource was created and/or associated with a security policy.

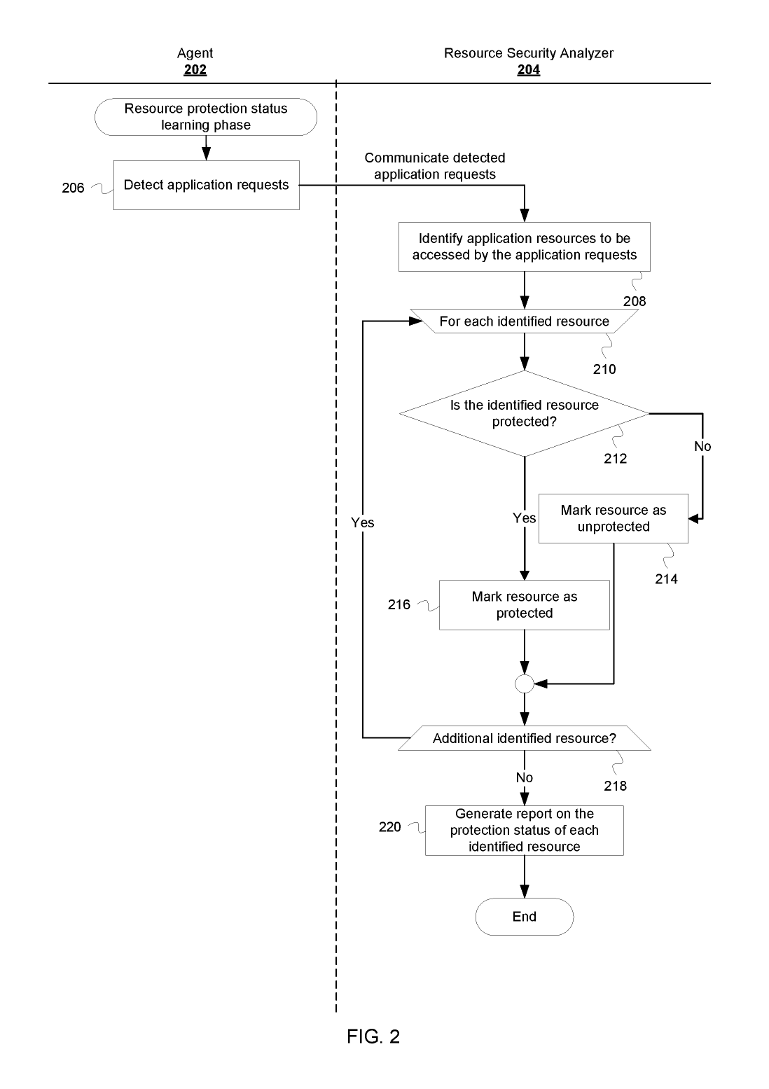

FIG. 2 is a flowchart of example operations depicting the learning phase of the resource security analyzer with an agent. The description in FIG. 2 refers to an agent (202), and a resource security analyzer (204) performing the example operations for consistency with FIG. 1. The agent (202) and the resource security analyzer (204) are part of a system that determines the protection status of the resources accessed by application requests from various clients.

As stated earlier, the resource security analyzer 204 includes an agent 202 that detects the application requests from various clients (206). The agent 202 records the detected application requests. For example, the agent 202 may create a log file that contains the detected application request. An example of the content of the log file is shown below:
2016-12-10 18:51:20 192.168.1.118 GET/owa/userspecificresource.aspx
ver=15.0.620 CACHE-HIT-06X-ARR
2016-12-10 18:51:20 192.168.1.118 GET/owa/protectionDomain1/database
ver=SQL11.2012
2016-12-10 18:51:20 192.168.1.118 GET/owa/logon.aspx
url:http://%3a %2fuserLogon.aspx ver=15.0.620
. . .

The agent 202 generates a list of the detected application requests and transmits the list to the resource security analyzer 204. Such information may be detected using instrumentation, one example of which is byte code instrumentation. The agent 202 inserts probes into the bytecode of the application. Inserting the probes into the bytecode is part of the instrumentation process that enables the detection of the application requests dynamically. The bytecode instrumentation may be inserted at the worker threads of the application such that each application request can be detected. Each of the web servers hosting the application may also be instrumented with an agent. Each of the agents detects the application requests to the web server. Each of the agents then communicates the detected application requests to the agent 202 of the resource security analyzer 204. The agent 202 aggregates the application requests detected by the agents and transmits the aggregated application requests to the resource security analyzer 204. The agents transmit the application requests using standard network protocol(s). The communication between the various devices (e.g., agent 202, resource security analyzer 204, policy server, policy store, application, web server) is governed by rules and/or discovery functions for detecting and identifying devices. For example, a dynamic host configuration protocol (DHCP) server may be used to assign IP addresses and provide configuration information.

The resource security analyzer 204 identifies the resources accessed by the application requests in the received list (208). The detected requests may be used to identify the resources accessed by the application requests. For example, the resource security analyzer 204 may identify the resources by various means such as extracting or parsing the URL, header or the name of the resource from the application request body and/or the operation to be performed by the application requests (e.g., GET, POST). Below is an example of an application request header container a database resource:
GET/example HTTP/1.1
Host: database1:8982
Accept: application/json

The resource security analyzer 204 may also identify the resources using metadata associated with the application requests. For example, the resource security analyzer 204 parses the URL and identifies the servlet name in the application request. As stated earlier, the resource security analyzer 204 also maps the application requests to each of the resources accessed by the application requests.

After each of the resources are identified, a loop begins for each of the identified resource (210). For each of the identified resource, the resource security analyzer 204 determines if the identified resource is protected (212). The resource security analyzer 204 may determine if the identified resource is protected by communicating to a policy server. The resource security analyzer 204 may communicate with the policy server using a policy management application interface (API). For example, the resource security analyzer 204 may call a policy management API that returns a Boolean which indicates whether the resource is protected or not. In another example, the policy management API may return a Hypertext Transfer Protocol (HTTP) 401 unauthorized status code if the resource is protected. If the resource is not protected, access to the resource is allowed.

The resource security analyzer 204 may also determine if the resource is protected by determining if the resource is associated with a protection domain. In another example, the resource security analyzer may also determine if the resource is mapped to a security policy, user, group and/or role. The user, group and/or rule mapping may be defined a configuration or a webLogic.xml file. The resource security analyzer may also use other methods to determine if the resource is protected such as, identifying security metadata annotation, parsing the log files, etc.

If the resource is protected, the resource security analyzer 204 marks the resource as protected (216). The resource security analyzer 204 may mark the resource as protected by using a field or flag. For example, the flag may be set to a bit that contains a 1 to indicate the resource is protected.

If the resource is not protected, the resource security analyzer 204 marks the resource as unprotected (214). The resource security analyzer 204 may mark the resource as unprotected by using a field or flag to indicate that the resource is unprotected. For example, the flag may be set to a bit that contains a 0 to indicate the resource is unprotected.

If there is an additional identified resource (218), the resource security analyzer 204 selects the next identified resource (210). If there no additional resource, the resource security analyzer 204 generates a report on the protection status of each of the identified resources (220).

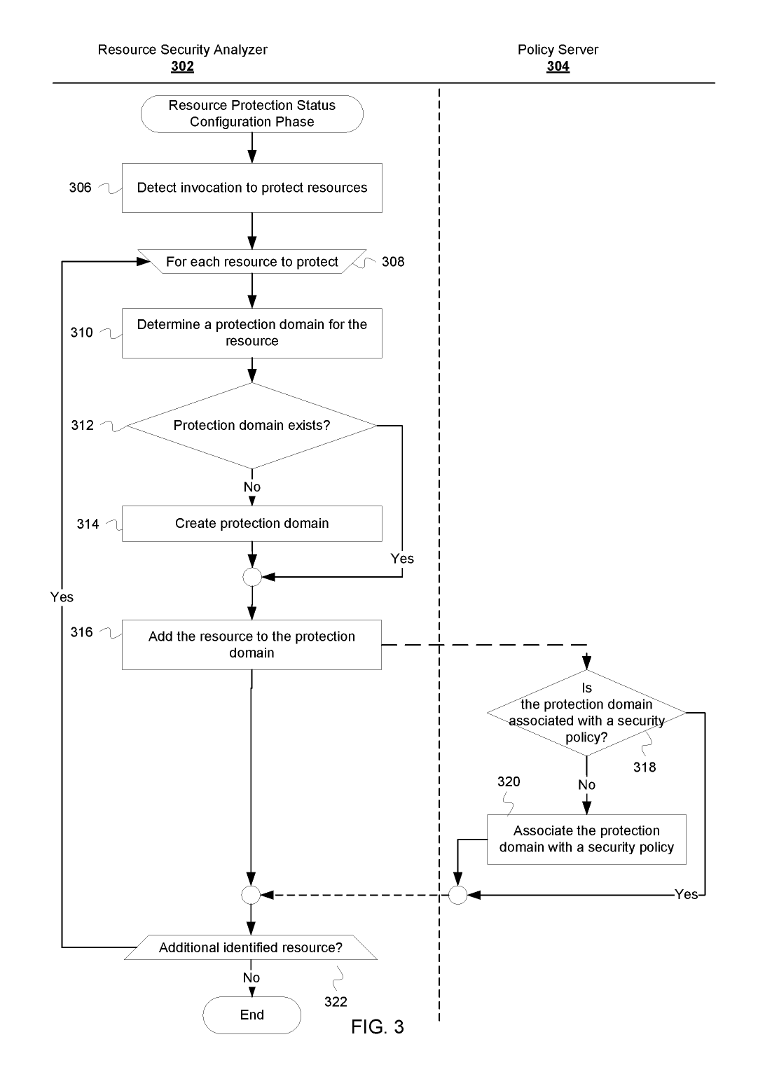

FIG. 3 is a flowchart of example operations depicting the configuration phase of the resource security analyzer of protecting an unprotected resource. The description in FIG. 3 refers to a resource security analyzer (302), and a policy server (304) performing the example operations for consistency with FIG. 1. The resource security analyzer (304) are part of a system that determines the desired protection status of the resources of an application(s).

The resource security analyzer 302 receives an invocation to protect resources (306). The invocation may be received through a selection of a submit button in a report displayed in a graphical user interface dashboard. The invocation may also be received from a method, module and/or component of the resource security analyzer 302 which may be triggered by the generation of a report on the protection status of the resources. The invocation may contain a list of resources to be protected. The list may contain the resource identifiers (ID), resource type, security policy ID, etc. The invocation may also contain information on the action (e.g., GET, POST) to be performed on the resource. Finally, the request may contain information about the location of the resource, such as web server identifier, IP address, etc.

After receiving an invocation to protect a resource, a loop begins for each of the resources to be protected (308). The resource security analyzer 302 learns the desired protection status of the resource (310). As stated earlier, the invocation may be received through a selection of input controls (e.g., checkboxes, radio button, drop-down text box, etc.) in a report displayed in a graphical user interface dashboard. The resource security analyzer 302 may also learn the desired protection status for the resource by querying the policy server 304. The resource security analyzer 302 may also query the policy server 304 for a security policy and/or protection domain associated with the resource. The security policy contains the identifier of the protection domain associated with the security policy.

The resource security analyzer 302 may use a rule-based classification and/or heuristics to learn or determine the desired protection status of the resources. The determination of the desired protection status may account for the operation of the application request, resource type, data, etc. For example, rule-based classification may indicate that certain resource types such as databases should be protected. In addition, the rule-based classification may further determine the protection domain and subdomain, if any, of the resource. After determining the desired protection status of the resource, the resource security analyzer 302 compares the desired protection status with the current protection status of the resource as indicated in the report. The resource security analyzer 302 updates the protection status to the desired protection status if there is a discrepancy between the desired protection status and the current protection status of the resource. For example, the resource security analyzer 302 updates the protection status of an unprotected resource. The resource security analyzer 302 records the resource identifiers of the resources to be protected.

In another example, the rule-based classification may determine the protection domain by determining an application layer where the resource belongs. Application layers (e.g., business, presentation, services, data) describe the logical division of application components and/or resources. The rule-based classification may state that resources that belong to an application layer should belong to the protection domain for that application layer or the owner of the resource. For example, marketing information that resides in the presentation layer of the application might be configured as part of a protection domain administered by the marketing department. An additional rule may be applied to resources in the application layer. For example, an additional rule based on how sensitive or valuable the data processed by the resources in the application data layer, may be applied. In this example, the protection domain may have a different subdomain for resources that process confidential, sensitive or “internal use only” data.

The resource security analyzer 302 may be implemented with a rule-based classification system that works in conjunction with the machine-learning techniques that allow specific changes that should be made to the groupings of the resources in the protection domain. The aforementioned rule-based classification may use a set of rules stored in a storage accessible by the resource security analyzer 302. The set of rules can include one or more rules. An example of a rule may be of a format:

If resourceType=database and accessType=confidential then
protectionDomain=databaseDomain and subDomain=
confidentialSubDomain

In some instances, more than one rule can be triggered by the resource(s) accessed by the application request. To account for these instances, a priority attribute can be added to the rules. For multiple matching rules, the rules can be applied in a priority order defined by the priority attribute. For example, assume that both rule A and rule B are triggered, the rule with the higher priority will be applied first. In other embodiments, the rule with the higher priority would be applied first while other rules would not be applied. If no rule is triggered, the resource can be determined to be unprotected.

In another example, the resource security analyzer 302 may determine the protection domain for the resource by retrieving a mapping information between the resource and the protection domain, etc. The mapping information may be retrieved from various sources such as a configuration file, a mapper file, etc. An example of the mapping is shown below:

```
<mapping>
  <local-path>c:/user/gifs</local-path>
  <url-resourceType>/images/*</url-resourceType>
  <url-resourceFormat>*.jpg</url-resourceFormat>
  <url-resourceDomain>imagesDomain</url-resourceDomain>
</mapping>
```

In yet another example, the resource security analyzer 302 may use the application requests logs to determine the protection domain of the identified resources. The resource security analyzer 302 may use log mining techniques to parse the application requests logs. The parsed information may be used to study patterns in the use of resources by extracting resource properties and the protection domains associated with the extracted resource properties for example. The extracted information may be used to determine the protection domains of the identified resources.

After determining the desired protection status and/or protection domain, the resource security analyzer 302 determines if the protection domain already exists (312). The technique used to determine if the protection domain already exists can vary. For example, the resource security analyzer 302 may query a protection domain manager to determine if the protection domain exists. In another example, a script may be used to extract domain information from an application configuration file.

If the protection domain already exists, the resource security analyzer 302 adds the resource to the protection domain (316). To add a resource to a domain, a reference to the resource may be associated with the protection domain identifier. This association may be added in a protection domain object that represents the protection domain. The protection domain object may be a data structure that contains properties of the protection domain.

If the protection domain does not exist, the resource security analyzer 302 creates the protection domain (314) and then adds the resource to the created protection domain (316). After adding the resource to the protection domain, the resource security policy analyzer determines if the protection domain is associated with a security policy (318). As stated earlier, the protection domain may not be associated with a security policy after the initial creation of the protection domain. The security policy represents the rules and criteria that constraints the activities of the resources that belong to the protection domain. The security policy may be represented by a security policy object. The security policy object may be a data structure that contains the properties of the security policy object. The security policy object also contains the association of the security policy object to a protection domain. The security policy object may be a data structure that contains the properties of the security policy object (e.g., policy identifier, domain identifier, policy type, date and time of creation, etc.).

The operations to determine if the protection domain is associated with a security policy can vary. For example, a protection domain object may be queried to determine if a protection domain is associated with the security policy. If the protection domain object has an associated security policy object, the protection domain object contains the associated security policy identifier. If the protection domain object has no associated security policy object, the protection domain object does not contain the security policy identifier. As another example, a database or a mapping table may be queried to determine if the protection domain is associated with the security policy.

If the protection domain is not associated with the security policy, the resource security analyzer 302 associates the protection domain with the security policy (320). The protection domain may be associated with the security policy by adding the security policy identifier to the protection domain object. As another example, the security policy identifier may be associated with the protection domain identifier using mapping structures such as a database or a mapping table. In yet another example, a hash table is used to keep track of the association of the protection domains and security policies. This allows the policy server to quickly look up the protection domains associated with the security policy.

If there is an additional identified resource (322), the resource security analyzer 302 selects the next identified resource (308). If there no additional resource, the process ends.

Variations

The above example illustrations presume that a request to protect a resource may be invoked from a user interface such as by selecting a checkbox, radio button, etc. A request to unprotect a resource may also be invoked from the user interface such as by unselecting a checkbox, radio button, etc. If the request was to unprotect the resource, the resource security analyzer removes the resource from the protection domain. The resource security analyzer removes the resource from the protection domain by disassociating the resource from the protection domain. The resource security analyzer may disassociate the resource from the protection domain by removing the mapping of the resource with the protection domain.

The above example illustrations presume that a request to protect a resource may be invoked from a user interface such as by selecting a checkbox, radio button, etc. A request to update the security policy may be invoked from the user interface. For example, a separate checkbox, radio button, etc. may be selected to update the security policy of the resource. If the request was to update the security policy associated with the resource, the resource security analyzer first determines the protection domain associated with the resource. After determining the protection domain associated with the resource, the resource security analyzer determines the desired protection domain that the resource should be associated with. Let the protection domain associated with the resource be the first protection domain. Let the desired protection domain that should be associated with the protection domain, be the second protection domain. The resource security analyzer determines if the first protection domain is the same as the second protection domain. If it is not the same, then the resource security analyzer moves the resource from the first protection domain to the second protection domain. The resource security analyzer may move the resource by disassociating the resource from the first protection domain and associating the resource with the second protection domain.

The above example illustrations presume that a request to protect a resource may be invoked from a user interface such as by selecting a checkbox, radio button, etc. or from a method within the resource security analyzer. The resource security analyzer may also receive the invocation to protect a resource from other sources such as the machine learning engine. The machine learning engine may be configured to learn the desired protection status of the resources. The machine learning engine may transmit a list of resources to be protected along with the invocation. The list may be in various format such as data structure, a file (e.g., text, XML file), cookie, etc.

The examples often refer to an “analyzer.” The analyzer is a construct used to refer to the implementation of functionality for determining the protection status of an application resource. This construct is utilized since numerous implementations are possible. The term is used to efficiently explain the content of the disclosure. Although the examples refer to operations being performed by an analyzer, different entities can perform different operations. For instance, a dedicated co-processor or application specific integrated circuit can determine protection status of an application resource.

The flowcharts are provided to aid in understanding the illustrations and are not to be used to limit the scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of the platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or a combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object-oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

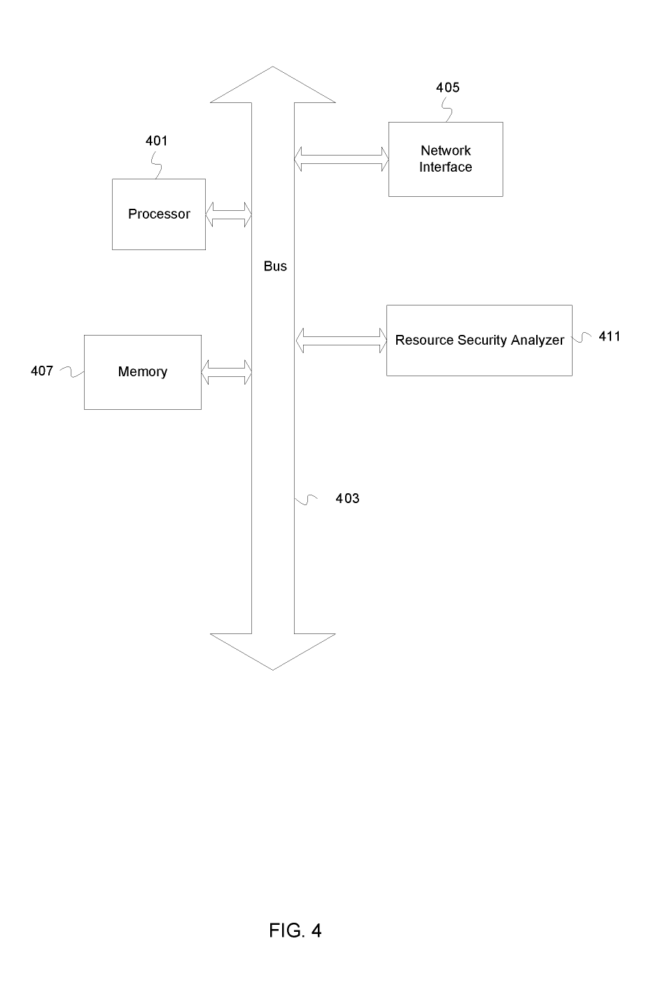

FIG. 4 depicts an example computer system with a resource security analyzer. The computer system includes a processor unit 401 (possibly including multiple processors, multiple cores, multiple nodes, and/or implementing multi-threading, etc.). The computer system includes memory 407. The memory 407 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 403 (e.g., PCI, ISA, PCI-Express, HyperTransport® bus, InfiniBand® bus, NuBus, etc.) and a network interface 405 (e.g., a Fiber Channel interface, an Ethernet interface, an internet small computer system interface, SONET interface, wireless interface, etc.). The system also includes a resource security analyzer 411. The resource security analyzer 411 collects application requests and evaluates the protection status of the resources accessed by the application requests. Any one of the previously described functionalities may be partially (or entirely) implemented in hardware and/or on the processor unit 401. For example, the functionality may be implemented with an application specific integrated circuit, in logic implemented in the processor unit 401, in a co-processor on a peripheral device or card, etc. Further, realizations may include fewer or additional components not illustrated in FIG. 4 (e.g., video cards, audio cards, additional network interfaces, peripheral devices, etc.). The processor unit 401 and the network interface 405 are coupled to the bus 403. Although illustrated as being coupled to the bus 403, the memory 407 may be coupled to the processor unit 401.

While the aspects of the disclosure are described with reference to various implementations and exploitations, it will be understood that these aspects are illustrative and that the scope of the claims is not limited to them. In general, techniques for collection of application requests and determining protection status of resources accessed by the application requests as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

### Terminology

The term “agent” as used in the application refers to an implementation of the functionality for detecting and/or intercepting web application resource. This construct is utilized since numerous implementations are possible. The term is used to efficiently explain content of the disclosure. The agent can also be referred to as an instrument. An application may be instrumented with an agent by installing a software probe on the resource or by initiating a process on the web application that executes program code for the agent. Although the examples refer to operations being performed by a agent, different entities can perform different operations. For instance, a dedicated co-processor or application specific integrated circuit can detect and/or intercept a web application resource.

This description uses the term “application component” to refer to any logical partition of functionality, software used to execute portions of the application (e.g., library file, plug-in, etc.), data storage used during execution of the application (e.g., queues, databases, etc.), or any other components usable within the application. For instance, an application component can be operations (e.g., a servlet) to provide for a user login and authentication into a website. In another instance, an application component can be operations to allow a user to access their account balance from an account balance database. An application component can also be a database from which data is accessed during execution of the application. Additionally, an application component can be some type of queues or other data structures used during execution of the application. A component may include other components. For example, a server component may include a web service component which includes a web application component.

As used herein, the term “or” is inclusive unless otherwise explicitly noted. Thus, the phrase “at least one of A, B, or C” is satisfied by any element from the set {A, B, C} or any combination thereof, including multiples of any element.

What is claimed is:

1. A method comprising:
detecting requests for a server process of an application instance;
identifying resources to be accessed for the requests based, at least in part, on the detected requests;
determining whether the identified resources are protected based on a set of one or more security policies;
based on a determination that at least a first of the resources is unprotected and an indication to protect the first resource,
determining a first protection domain for the first resource;
associating the first protection domain with a first security policy; and
adding the first resource to the first protection domain associated with the first security policy to protect the first resource.

2. The method of claim 1 wherein determining whether the identified resources are protected comprises communicating identifiers of the resources with a set of one or more policy servers for the set of one or more policy servers to determine protection status of each of the identified resources based on the set of one or more security policies.

3. The method of claim 1 further comprising, generating a report that indicates protection status of each of the identified resources based on the determination of whether the identified resources are protected.

4. The method of claim 3, wherein generating the report comprises generating a user interface with selectable indications to change protection status of each of the identified resources.

5. The method of claim 4, further comprising detecting selection of at least a first of the selectable indications that corresponds to the first resource, wherein the indication to protect the first resource comprises detection of selection of the first selectable indication.

6. The method of claim 1 further comprising:
determining classifications of the identified resources;
evaluating the determined classifications against a set of classification-based protection rules; and
generating the indication to protect the first resource based, at least in part, on the evaluating of the determined classifications against the set of classification-based protection rules.

7. The method of claim 1 further comprising:
evaluating a historical log of protection status changes of resources to determine similarity of resource attributes between resources indicated in the historical log and the identified resources; and
generating the indication to protect the first resource based, at least in part, on a determination that the first resource has a first resource attribute similar to a resource indicated as protected in the historical log.

8. The method of claim 1 wherein determining a first protection domain comprises creating a first protection domain.

9. The method of claim 8, wherein creating the first protection domain comprises creating a logical grouping of resources associated with the same security policy of the set of one or more security policies.

10. The method of claim 1 wherein associating the first protection domain with the security policy comprises associating a first protection domain identifier with a first security policy identifier in hash table.

11. One or more non-transitory machine-readable media comprising program code for application request based protection status discovery and evaluation of resources, the program code to:
detect requests for a server process of an application instance;
identify resources to be accessed for the requests based, at least in part, on the detected requests;
determine protection statuses of the identified resources;
detect a set of one or more indications of protection status change to protected for a set of one or more of the identified resources;
for each of the identified resources for which indication of protection status change to protected is detected,
determine a protection domain for the resource;
associate the protection domain with a security policy; and
add the resource to the protection domain associated with the security policy to protect the resource according to the security policy.

12. The machine-readable media of claim 11 further comprising program code to:
generate a report that indicates protection status of each of the identified resources based on the determination of protection statuses.

13. The machine-readable media of claim 11, further comprising program code to:
determine classifications of the identified resources;
evaluate the determined classifications against a set of classification-based protection rules; and
generate the set of one or more indications of protection status change based, at least in part, on the evaluation of the determined classifications against the set of classification-based protection rules.

14. The machine-readable media of claim 11, further comprising program code to:
evaluate a historical log of protection status changes of resources to determine similarity of resource attributes between resources indicated in the historical log and the identified resources; and
generate the set of one or more indications based, at least in part, determinations of similarity of resource attributes between the set of one or more of the identified resources and at least a subset of the resources indicated as protected in the historical log.

15. The machine-readable media of claim 11, wherein the program code to determine protection statuses comprises program code to communicate identifiers of the identifies resources to a set of one or more policy servers for the set of one or more policy servers to determine protection statuses based on the communicated identifiers

16. An apparatus comprising:
a processor; and
a machine-readable medium having program code executable by the processor to cause the apparatus to,
detect requests for a server process of an application instance;
identify resources to be accessed for the requests based, at least in part, on the detected requests;
determine whether the identified resources are protected based on a set of one or more security policies;
based on a determination that at least a first of the resources is unprotected and an indication to protect the first resource,
determine a first protection domain for the first resource;
associate the first protection domain with a first security policy; and
add the first resource to the first protection domain associated with the first security policy to protect the first resource.

17. The apparatus of claim 16, wherein the program code to determine whether the identified resources are protected comprises program code to:
communicate identifiers of the resources with a set of one or more policy servers for the set of one or more policy servers to determine protection status of each of the identified resources based on the set of one or more security policies.

18. The apparatus of claim 16, wherein the machine-readable medium further comprises program code executable by the processor to cause the apparatus to:
generate a report that indicates protection status of each of the identified resources based on the determination of whether the identified resources are protected.

19. The apparatus of claim 16, wherein the machine-readable medium further comprises program code executable by the processor to cause the apparatus to:
determine classifications of the identified resources;
evaluate the determined classifications against a set of classification-based protection rules; and
generate the indication to protect the first resource based, at least in part, on the evaluation of the determined classifications against the set of classification-based protection rules.

20. The apparatus of claim 16, wherein the machine-readable medium further comprises program code executable by the processor to cause the apparatus to:
evaluate a historical log of protection status changes of resources to determine similarity of resource attributes between resources indicated in the historical log and the identified resources; and
generate the indication to protect the first resource based, at least in part, on a determination that the first resource has a first resource attribute similar to a resource indicated as protected in the historical log.
